(19) United States
(12) Patent Application Publication
(10) Pub. No.: US 2016/0202929 A1
(43) Pub. Date: Jul. 14, 2016

(54) DATA PROTECTION METHOD AND ELECTRONIC DEVICE USING THE SAME

(71) Applicant: LITE-ON TECHNOLOGY CORPORATION, Taipei (TW)

(72) Inventor: Chi-Ming LO, Taipei (TW)

(73) Assignee: LITE-ON TECHNOLOGY CORPORATION, Taipei (TW)

(21) Appl. No.: 14/642,731

(22) Filed: Mar. 9, 2015

(30) Foreign Application Priority Data
Jan. 14, 2015 (CN) 201510017604.1

(51) Int. Cl. G06F 3/06

(52) U.S. Cl. CPC G06F 3/0622; G06F 3/0637; G06F 3/0673; G06F 3/0664

(57) ABSTRACT

A data protection method is provided. The data protection method includes the following steps. Firstly, response to a setting for a first hot key, the first hot key is stored and a first virtual storing unit in a storing element is established. Then, response to a first-time input for the first hot key, a frame of the first virtual storing unit is displayed.

This application claims the benefit of People's Republic of China application Serial No. 201510017604.1, filed on Jan. 14, 2015, the subject matter of which is incorporated herein by reference.

### BACKGROUND

1. Technical Field

The disclosure relates in general to a data protection method and an electronic device using the same, and more particularly to a data protection method using a hot key and an electronic device using the same.

2. Background

In conventional, when a file management program is executed, almost all data stored in a computer is displayed. As a result, the displayed data may be subjected to a risk of data being stolen, even if the displayed data is protected by password.

### SUMMARY

The invention is directed to a data protection method and an electronic device using the same, the risk of data being stolen may be reduced.

According to one embodiment of the invention, a data protection method is provided. The data protection method includes the following steps. Response to a setting for a first hot key, storing the first hot key and establishing a first virtual storing unit in a storing element; and response to a first-time input for the first hot key, displaying a frame of the first virtual storing unit.

According to another embodiment of the invention, an electronic device is provided. The electronic device includes a display unit, a storing unit, an input unit and a processor. The storing unit is for storing data. The input unit is for receiving a setting for a first hot key. The processor is for operating in: response to the setting for the first hot key, storing the first hot key and establishing a first virtual storing unit in the storing element; and response to a first-time input for the first hot key, displaying a frame of the first virtual storing unit.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of a data protection method according to an embodiment of the invention;

FIG. 2 shows a diagram of an electronic device according to an embodiment of the invention;

FIG. 3 shows a frame of the file management program being displayed by the display unit of FIG. 2;

FIG. 4 shows a diagram of operation method of the first virtual disk of FIG. 3; and

FIG. 5 shows a flowchart of a data protection method according to another embodiment of the invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

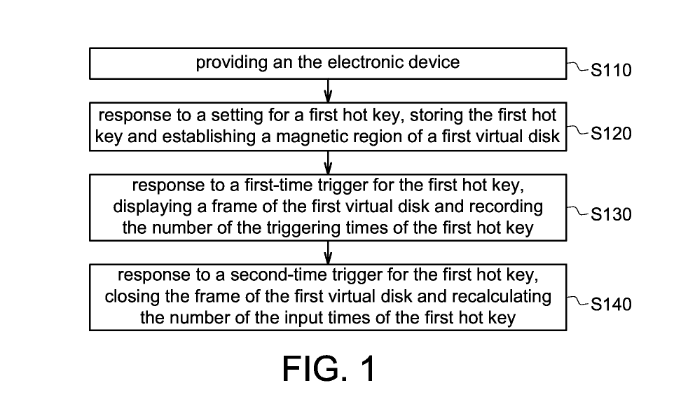

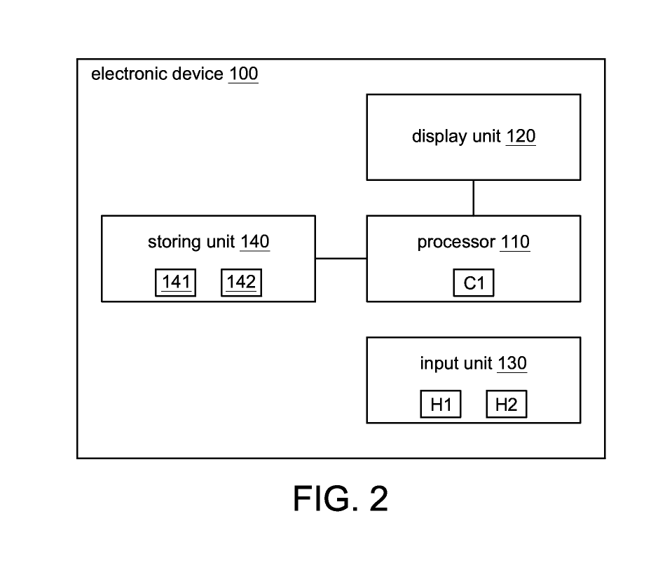

Referring to FIGS. 1 and 2, FIG. 1 shows a flowchart of a data protection method according to an embodiment of the invention, and FIG. 2 shows a diagram of an electronic device according to an embodiment of the invention.

In step S110, the electronic device 100 is provided, wherein the electronic device 100 includes a processor 110, a display unit 120 and an input unit 130. The electronic device 100 is, for example, a desktop computer, notebook, a tablet computer, a cell phone, etc. The input unit 130 is, for example, a physical keyboard, a virtual keyboard, a physical key, a virtual key or other apparatus capable of receiving an instruction. The electronic device 100 further includes a storing unit 140 for storing data. The storing unit 140 may be conventional hard disk, solid state disk (SSD), memory, etc.

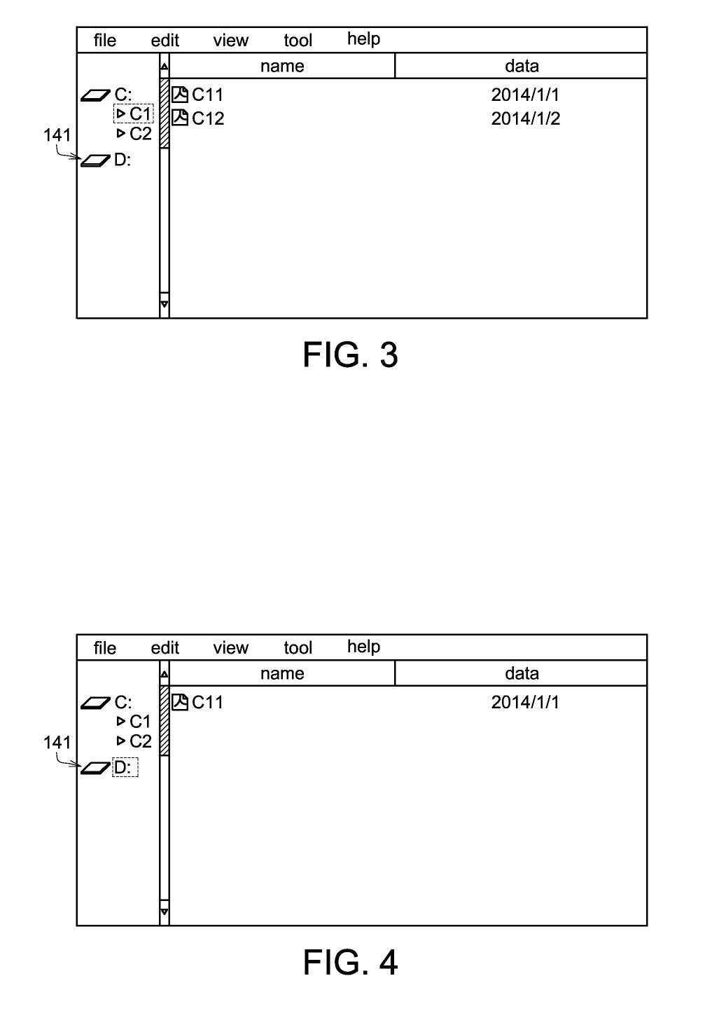

In step S120, after the processor 110 loads a data protection program C1, the first user may input a first hot key H1 through the input unit 130 for establishing a first virtual storing unit 141 and storing the first hot key H1. Examples of the storing unit 140 being a conventional hard disk, the first virtual storing unit 141 is a first virtual disk 141, and a size of magnetic region of the first virtual disk 141 may be determined by user. The first hot key H1 may serve as a hot key for displaying or closing a frame of the first virtual disk 141 in the display unit 120. A displayed frame of the first virtual disk 141 is shown in FIG. 3. After a setting for the first hot key H1 and the first virtual disk 141 and before the first hot key H1 has not triggered yet, the number of trigger times of the first hot key H1 is set as zero and the first virtual disk 141 is not displayed.

In detail, the processor 110 distributes a magnetic region of the storing unit 140 as the first virtual disk 141 for storing various data. In this step, the relationship between the first virtual disk 141 and the first hot key H1 is completed.

Since the data stored in the magnetic region of the virtual disk is package into a mirror file by binary form, it is not easy to obtain the data stored in the magnetic region of the virtual disk by searching or other decoding way. As a result, an effect on security can be reached.

Then, the first user may trigger the first hot key H1 to display the disk format of the magnetic region of the first virtual disk 141, as described below.

In step S130, referring to FIG. 3, FIG. 3 shows a frame of the file management program is displayed by display unit of FIG. 2. After the first user triggers the first hot key H1, the processor 110 controls the display unit 120 to display the file management program response to the trigger for the first hot key H1. The file management program displays file data which have stored in disk C and the frame of the first virtual disk 141 corresponding to the first hot key H1. In the present embodiment, the first virtual disk 141 is disk D, for example. In another embodiment, the first virtual disk 141 may be represented by other symbol or alphabet.

FIG. 4 shows a diagram of operation method of the first virtual disk of FIG. 3. After the frame of the first virtual disk 141 is displayed, the data which is intended to be protected may be edited, opened, deleted, removed, copy, set for the attribute by the first user. For example, as shown in FIG. 4, the first user may remove a file C11 of a folder C1 to the first virtual disk 141 in the file management program. In another embodiment, after the frame of the first virtual disk 141 is displayed, the first user also may remove a file and/or data of the first virtual disk 141 to other non-virtual disk for lifting the protection for the file and/or data.

In step S130, the processor 110 records the number of the trigger times as once response to the first-time trigger for the first hot key H1.

The first user may trigger the first hot key H1 again for closing the frame of the first virtual disk 141. As a result, the data which is intended to be protected may be hidden, and thus the risk of data being stolen may be reduced. As described in S140 below.

In step S140, the first user may trigger the first hot key H1 again. The processor 110 controls the display unit 120 to close the frame of the first virtual disk 141 response to the second-time trigger for the first hot key H1. That is, when the first hot key H1 is triggered twice, the processor 110 controls the display unit 120 to close the frame of the first virtual disk 141. As a result, the data which is intended to be protected may be prevented from being displayed in the file management program, and the risk of data being stolen may be reduced. In addition, when the number of the trigger times of the first hot key H1 is two, the number of the trigger times of the first hot key H1 will be recalculated (that is, returns to zero). After returning to zero, the next-time input for the first hot key is redefined as the first-time input. If user inputs the first hot key again, the file management program displays the frame of the first virtual disk 141.

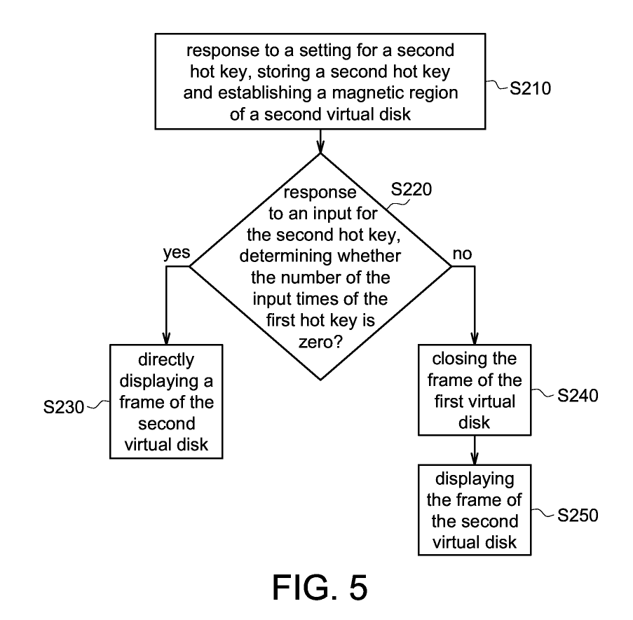

FIG. 5 shows a flowchart of a data protection method according to another embodiment of the invention.

In step S210, after the processor 110 loads the data protection program C1, the second user may input a second hot key H2 through the input unit 130 to establish a second virtual disk 142. The second hot key H2 may serve as the hot key capable of displaying or closing the second virtual disk 142.

In step S210, the processor 110 establishes a magnetic region of the second virtual disk 142. In detail, the processor 110 distributes a magnetic region of the storing unit 140 as the second virtual disk 142 for storing various data. In this step, the relationship between the second virtual disk 142 and the second hot key H2 is completed.

Then, the second user may trigger the second hot key H2 to display the disk format of the magnetic region of the second virtual disk 142, as described below.

In step S220, after the second user triggers the second hot key H2, the processor 110 determines whether the number of the trigger times of the first hot key H1 is zero; if the number of the trigger times of the first hot key H1 is zero, it means that the frame of the first virtual disk 141 has been closed, and the processor 110 controls the display unit 120 to directly display the frame of the second virtual disk 142 (in step S230); if the number of the trigger times of the first hot key H1 is not zero, it means that the frame of the first virtual disk 141 has not been closed yet, and the processor 110 controls the display unit 120 to close the frame of the first virtual disk 141 (in step S240) and then to display the frame of the second virtual disk 142 (in step S250).

In the present embodiment, under the circumstance of the several virtual disks and the corresponding hot keys, before the frame of the virtual disk is displayed response to the currently input hot key, whether other virtual disk is closed is determined. As a result, since the frame of the first virtual disk 141 is closed before the second virtual disk 142 is displayed, the displayed data of the first virtual disk 141 is prevented from being observed or seen by other user and thus the risk of data being stolen can be reduced.

To summarize, in the data protection method disclosed in above embodiments of the invention, the data which is intended to be protected is stored in the storing unit. As a result, it is not easy to obtain data which is intended to be protected by searching. In addition, since the frame of the virtual disk may be displayed or closed by using hot key, the security of the data and speed of displaying the virtual disk can be increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A data protection method, comprising:
response to a setting for a first hot key, storing the first hot key and establishing a first virtual storing unit in a storing element; and
response to a first-time input for the first hot key, displaying a frame of the first virtual storing unit.

2. The data protection method according to claim 1, further comprising:
response to the first-time input for the first hot key, recording the number of input times as once.

3. The data protection method according to claim 2, further comprising:
response to a second-time input for the first hot key, closing the frame of the first virtual storing unit and recording the number of the input times of the first hot key as zero.

4. The data protection method according to claim 1, further comprising:
response to a setting for a second hot key, storing the second hot key and establishing a second virtual storing unit in the storing element.

5. The data protection method according to claim 4, further comprising:
response to an input for the second hot key, determining whether the number of the input times of the first hot key is zero; and
if the number of the input times of the first hot key is zero, displaying a frame of the second virtual storing unit.

6. The data protection method according to claim 5, further comprising:
if the number of the input times of the first hot key is not zero, closing the frame of the first virtual storing unit; and
after the frame of the first virtual storing unit is closed, displaying the frame of the second virtual storing unit.

7. An electronic device, comprising:
a display unit;
a storing unit, for storing data;
an input unit, for receiving a setting for a first hot key; and
a processor, for operating in:
response to the setting for the first hot key, storing the first hot key and establishing a first virtual storing unit in the storing element; and
response to a first-time input for the first hot key, displaying a frame of the first virtual storing unit.

8. The electronic device according to claim 7, wherein the processor is further for operating in:
response to the first-time input for the first hot key, recording the number of input times as once.

9. The electronic device according to claim 8, wherein the processor is further for operating in:
response to a second-time input for the first hot key, controlling the display unit to close the frame of the first virtual storing unit and recording the number of the input times of the first hot key as zero.

10. The electronic device according to claim 7, wherein the processor is further for operating in:
response to a setting for a second hot key, storing the second hot key and establishing a second virtual storing unit in the storing element.

11. The electronic device according to claim 10, wherein the processor is further for operating in:
response to an input for the second hot key, determining whether the number of the input times of the first hot key is zero; and
if the number of the input times of the first hot key is zero, controlling the display unit to display a frame of the second virtual storing unit.

12. The electronic device according to claim 11, wherein the processor is further for operating in:
if the number of the input times of the first hot key is not zero, controlling the display unit to close the frame of the first virtual storing unit; and
after the frame of the first virtual storing unit is closed, controlling the display unit to display the frame of the second virtual storing unit.
